(19) United States
(12) Patent Application Publication
(10) Pub. No.: US 2016/0194903 A1
(43) Pub. Date: Jul. 7, 2016

(54) SLIDING DOOR LOCKING DEVICE

(71) Applicant: Padio Systems Inc., Vancouver (CA)

(72) Inventors: Bruce White, Vancouver (CA); Craig Gauld, Vancouver (CA); Bruce Miller, Coquitlam (CA)

(73) Assignee: Padio Systems Inc., Vancouver (CA)

(21) Appl. No.: 14/989,081

(22) Filed: Jan. 6, 2016

(30) Foreign Application Priority Data
Jan. 7, 2015 (CA) 2876791

(51) Int. Cl. E05B 47/00; E05D 15/06; E05B 51/00; G07C 9/00; E05C 21/00; E05B 53/00; E05B 49/00; E06B 3/46; E05C 19/00

(52) U.S. Cl. CPC E05B 47/0046; E06B 3/4636; E05D 15/06; E05B 51/00; E05C 19/003; E05C 21/00; E05B 53/00; E05B 49/002; G07C 9/00134; E05B 2047/0048; E05B 2047/0072

(57) ABSTRACT

A sliding door locking device, the sliding door having a frame that engages with a door jamb or a second sliding door frame. The device may include a locking body connected to the door jamb or second sliding door frame. The locking body may be linear alignment with a path of the first sliding door and the first sliding door frame may be configured to receive the locking body. A latching body may be connected to the first sliding door frame and operable to engage with the locking body. First and second controllers may be connected to the first door frame and operable to control the latching body towards and away the locking body. Bypass means may be connected to the first sliding door frame and in mechanical communication with the second controller and with the latching body. Authentication means may be in communication with the bypass means, wherein the bypass means renders the second controller inoperable until the authentication means verifies a user.

### FIELD OF THE INVENTION

The invention relates to the field of locks and in particular to a device for locking a sliding door.

### BACKGROUND OF THE INVENTION

Sliding patio doors are commonplace throughout the world. They consume less space than swing doors as their panels slide alongside one-another when opening or closing. Swing doors, on the other hand, swing through an arc requiring the area to be clear for opening or closing.

They are usually glazed and because large panels of glass provide the best views, sliding patio doors are often on the view side of homes, buildings or rental suites, providing access to patios, pools, back lanes, walkways, and beaches. Sliding doors are made up of a variety of materials, for example, glass panels, framed in metal, wood, vinyl, and/or fiberglass. Originally they may have been made of wood but most of the current older sliding door frames are now made from aluminum with relatively narrow stiles (side frame of panels). More recently, vinyl, fiberglass and some wood versions are offered as premium options and sell at a very popular rate. The vinyl/wood/fiberglass varieties tend to be made with wider stiles and therefore, offer more space for latches and locks and are typically made with latches mortised into the edge of the style. Locking occurs by providing lever operation of the mortise latch which is on the inside of the door stile.

Typically, sliding doors have two panels with one fixed in place while the other slides back and forth alongside the fixed panel on either the inside or outside of the fixed panel. Both panels are typically contained in a fixed outer frame of the same material as the panel frames. The sliding door unit is locked via a latching mechanism on the sliding panel that engages a hook, catch or hole in or fixed to the outer frame of the unit. This connection point on the frame may be enhanced via longer screw(s) into the framing members of the wall after installation. Locking is achieved by typically providing operation of the latching mechanism from only inside of the door. Other pins, buttons and sticks are often added to further secure the active panel to the outer frame or inactive panel. Some doors do have exterman keys but the security of such is limited to the weakest link in that chain of attachment and that is often the hook itself the hook to catch attachment or the catch itself.

When sliding doors are installed at ground level or on a low patio level, it would sometimes be useful to use such sliding doors as entrance or exit doors to permit true access to the pool, beach, walkway, car etc. Unfortunately most such sliding doors do not have a lock which would grant access from both the inside and outside.

The majority of existing installed aluminum patio doors simply do not have secure locks. One common type of lock for aluminum patio doors is a simple mechanism bolted through the stile of the active panel. On the outside it adds a surface mounted handle/pull to assist with moving of the door. On the inside it offers a surface mounted handle including lever on a pivot. On the opposite side of the pivot from the lever is typically a hook which, when levered, engages some form of catch or hole mounted on or in the outer fixed frame of the whole sliding door assembly. Typical locks can be thwarted by circularly jiggling the door, by sliding a blade up the side of the door, and by brute force by prying or by levering the whole door off and out of place.

There are many after-market devices which are available which are typically added along the bottom or top of the active panel to secure it to the base of the outer fixed frame. These vary in the method of their operation; for example, some are pins which require the user to bend down to engage or disengage while others are foot operated with a little button to lock and another to unlock. These aftermarket devices are at times difficult to engage/disengage, become jammed and are not easily operated. As a result they present a barrier to exit in the case of a fire or emergency and thus a danger.

There is a growing adoption of keyless entry via a keypad for normal swing doors. Homeowners can install a special device including a deadbolt which fits in standard doors with the same standard milling of holes and slots. These locks are not locked and unlocked via a key but via a special code via keypad. They typically can have several key codes programmed into them or removed by the owner via a keypad and a ‘master code’ for setup. These keypads offer considerable convenience as users do not have to carry or remember keys. They could be particularly appealing for people with children who might come and go without keys. Also growing but very leading edge is wireless entry, for example, an RFID fob or by using a smartphone via Bluetooth to provide the verification/key. These products are very new, but have very little market traction so far.

Accordingly, a need exists for an improved patio door locking device that overcomes the gap in today's marketplace. For either the aluminum type of sliding doors and for the vinyl type of doors with existing mortise latches in the stile of the active panel, the current invention provides an easy and convenient two way access via an external lever to lock and unlock the door from the exterior. The door gets locked by disengaging the exterior lever when the unit is latched. As a result, an authorized person can enter or exit freely while unauthorized cannot.

Also, security is increased via a pin-into-pin latching mechanism. This device is stronger and more tamper resistant than the typical lock on aluminum doors which is the lever-pivot-hook to latch type. The mortise latches typical on vinyl-type doors offer better latch security, than the latches typically found on aluminum framed units, but these mortise latches cannot be easily added to aluminum doors which typically have much narrower (too narrow) stile dimension. The current invention takes up less space longitudinally (in the direction of the panel movement) enabling it to fit better into narrow stiles. Even if mortise latches can fit they are much more difficult to install as it takes fairly precise machining of the edge of the door in complex shape(s) to take a mortise. Other objects of the invention will be apparent from the description that follows.

### SUMMARY OF THE INVENTION

According to the present invention there is provided a sliding door locking device, where the sliding door panel has a frame that engages with a door jamb or a second sliding door frame. The device may include a locking body connected to the door jamb or second sliding door frame. The locking body may be in linear alignment with a path of the first sliding door and the first sliding door frame may be configured to receive the locking body. A latching body may be connected to the first sliding door frame and operable to engage with the locking body. The device may further include a controller, such as a lever, connected to the first sliding door frame and operable to control the latching body towards and away from the locking body to lock and unlock with the locking body. The controller may be inoperable until the first sliding door frame is engaged with the door jamb or with the second sliding door frame.

The locking body and the latching body may be in perpendicular alignment with one-another in the locked position. Furthermore, the locking body may be configured for insertion into the first sliding door frame and the first sliding door frame may be configured to receive the locking body within the first sliding door frame. As such, the locking body and the latching body may lock to one-another inside of the first door frame's stile.

The latching body may be a clip configured to engage over the locking body. Alternatively, the locking body may include a through-bore and the latching body may be configured to pass through the through-bore.

The locking body may be a locking plate and a locking pin perpendicularly disposed thereon. As such, the locking plate may be configured for flush attachment to the door jamb or to the second sliding door frame. Alternatively, the locking body may be a frame pin and a locking pin longitudinally disposed thereon. As such, the frame pin may be configured for attachment into the door jamb or into the second sliding door. Still in the alternative, the locking body may be a cross bar and a locking pin perpendicularly disposed thereon. As such, the cross bar may be connected across and through the door jamb or second sliding door frame.

According to another embodiment of the present invention there is provided a sliding door locking device. Here, the sliding door may have a frame that engages with a door jamb or a second sliding door frame. The first frame may have an interior space exposure and an exterior space exposure. The first frame may include a latching body that engages with a corresponding locking body on the door jamb or second sliding door jamb. The device may include a first controller connected to the interior space exposure of the first door frame and operable to control the latching body. A second controller may be connected to the exterior space exposure of the first door frame and operable to control the latching body. The controllers may be, for example, levers. The device may also include bypass means connected to the first sliding door frame and in mechanical communication with the second controller and with the latching body. Authentication means may be provided in communication with the bypass means, wherein the bypass means renders the second controller inoperable until the authentication means verifies a user.

The bypass means may be a jammer, such as a tumbler, which prevents the second controller from operating the latching body until the authentication means verifies a user. Alternatively, the bypass means may be a clutch that disengages the mechanical communication between the second controller and the latching body until the authentication means verifies a user.

The authentication means may be a key. When the key is activated the jammer or clutch renders the second controller operable to communicate with the latching body.

The clutch may engage the mechanical communication between the second controller and the latching body when the authentication means verifies a user and when the second controller is in alignment with the first controller.

The bypass device may be in mechanical communication with the second controller via a bypass body and said bypass body passes through a control arm for a mortise latch, wherein the control arm passes through the keyway hole in a mortise latch.

According to yet another embodiment of the present invention there is provided a sliding door locking device. The sliding door may have a frame that engages with a door jamb or a second sliding door frame. The first frame may have an interior space exposure and an exterior space exposure. The device may include a locking body connected to the door jamb or second sliding door frame. The locking body may be in linear alignment with a path of the first sliding door and the first sliding door frame may be configured to receive the locking body. A latching body may be connected to the first sliding door frame and operable to engage with the locking body. The device may include a first controller connected to the interior space exposure of the first door frame and operable to control the latching body. A second controller may be connected to the exterior space exposure of the first door frame and operable to control the latching body. The controllers may be, for example, levers. The device may also include bypass means connected to the first sliding door frame and in mechanical communication with the second controller and with the latching body. Authentication means may be provided in communication with the bypass means, wherein the bypass means renders the second controller inoperable until the authentication means verifies a user.

The controllers may be inoperable until the first sliding door frame is engaged with the door jamb or with the second sliding door frame.

The locking body and the latching body may be in perpendicular alignment with one-another in the locked position. Furthermore, the locking body may be configured for insertion into the first sliding door frame and the first sliding door frame may be configured to receive the locking body within the first sliding door frame. As such, the locking body and the latching body may lock to one-another inside of the first door frame.

The latching body may be a clip configured to engage over the locking body. Alternatively, the locking body may include a through-bore and the latching body may be configured to pass through the through-bore.

The locking body may be a locking plate and a locking pin perpendicularly disposed thereon. As such, the locking plate may be configured for flush attachment to the door jamb or to the second sliding door frame. Alternatively, the locking body may be a frame pin and a locking pin longitudinally disposed thereon. As such, the frame pin may be configured for attachment into the door jamb or into the second sliding door. Still in the alternative, the locking body may be a cross bar and a locking pin perpendicularly disposed thereon. As such, the cross bar may be connected across and through the door jamb or second sliding door frame.

The bypass means may be a jammer, such as a tumbler, which prevents the second controller from operating the latching body until the authentication means verifies a user. Alternatively, the bypass means may be a clutch that disengages the mechanical communication between the second controller and the latching body until the authentication means verifies a user.

The authentication means may be a key. When the key is activated the jammer or clutch renders the second controller operable to communicate with the latching body.

The clutch may engage the mechanical communication between the second controller and the latching body when the authentication means verifies a user and when the second controller is in alignment with the first controller.

Other aspects of the invention will be appreciated by reference to the detailed description of the preferred embodiment and to the claims that follow.

### BRIEF DESCRIPTION OF THE DRAWINGS

The preferred embodiment of the invention will be described by reference to the drawings thereof in which:

FIG. 1a is an isometric view of a pin-in-pin embodiment of the invention;

FIG. 1b is a side elevation view of FIG. 1a;

FIG. 2 is an isometric exploded view of FIG. 1a;

FIG. 3a is an isometric exploded view of an embodiment of a locking body of the invention;

FIG. 3b is an isometric view of another embodiment of a locking body of the invention;

FIG. 3c is an isometric view of yet another embodiment of a locking body of the invention;

FIG. 3d is an isometric view of the locking body of FIG. 3c attached through a door jamb;

FIG. 4 is an isometric view of another embodiment of the invention in use with a standard mortise latch;

FIG. 5 is a side elevation exploded view of another embodiment of the invention in use with the pin-in-pin embodiment of FIG. 1a;

FIG. 6 is an isometric exploded view of a clutch of the present invention;

FIG. 7 is an isometric view of FIG. 4 as seen from an exterior perspective; and

FIG. 8 is an isometric view of FIG. 5 as seen from an exterior exposure.

### DESCRIPTION OF THE PREFERRED EMBODIMENT OF THE INVENTION

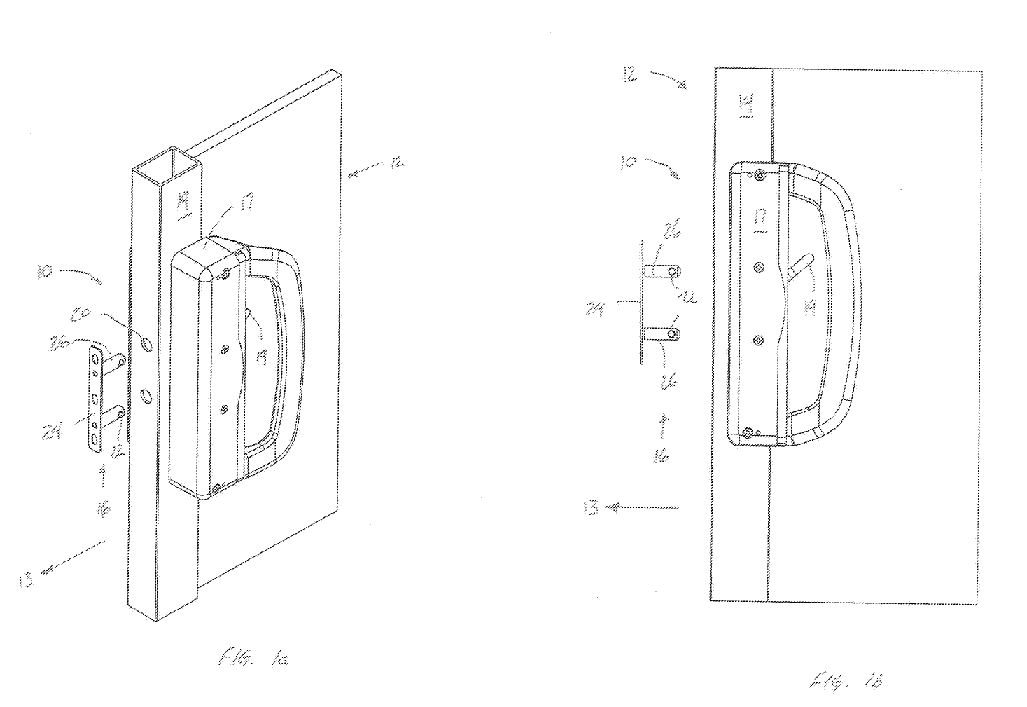

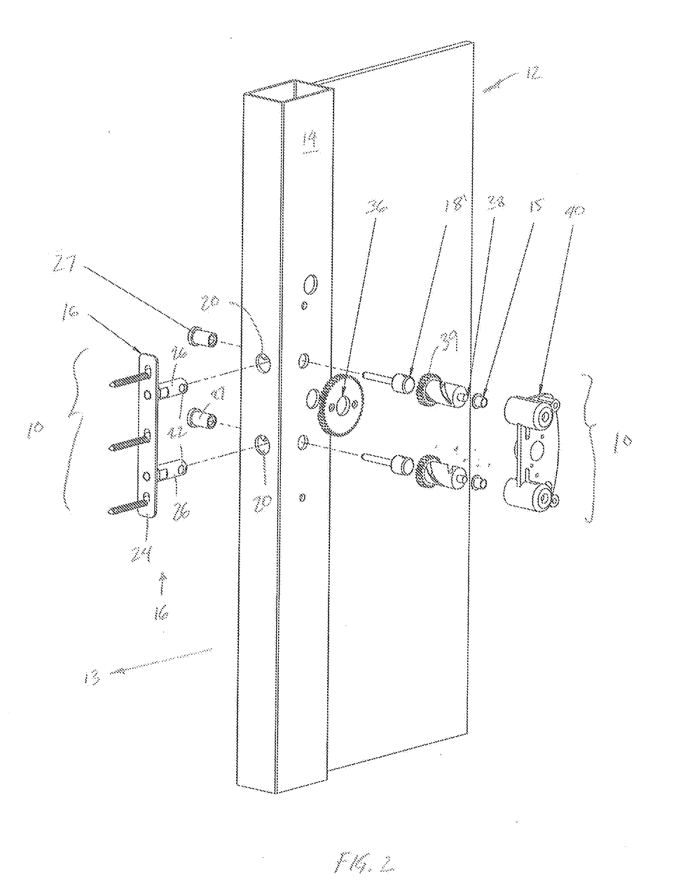

Referring to FIGS. 1a, 1b and 2, a sliding door locking device 10 is depicted. The sliding door 12 has a frame 14 that engages with a door jamb or a second sliding door frame (not depicted). Device 10 includes a locking body 16 connected to the door jamb or second sliding door frame. Locking body 16 is in linear alignment with a path 13 of the first sliding door 12 and the first sliding door frame 14 is configured to receive the locking body. A latching body 18 is connected to the first sliding door frame 14 and operable to engage with the locking body 16.

Device 10 includes a controller connected to the first sliding door frame 14 and operable to control the latching body 18 towards and away from the locking body 16 to lock and unlock with the locking body. As depicted, the controller is a standard lever 19 connected inside a standard handle housing 17, but as those skilled in the art will appreciate, any controller will suffice, such as a switch or knob. To prevent possible damage, lever 19 is inoperable until the first sliding door frame 14 is engaged with the door jamb or with the second sliding door frame.

In operation, locking body 16 and latching body 18 will be in perpendicular alignment with one-another in the locked position. Furthermore, locking body 16 will be configured for insertion into the first sliding door frame 14. First sliding door frame 14 will be configured to receive locking body 16 within the first sliding door frame. As depicted, sliding door frame 14 includes a hole 20 drilled into a receiving side to receive locking body 16. As such, locking body 16 and latching body 18 will lock to one-another inside of the first door frame 14.

Latching body 18 may be a clip configured to engage over locking body 16. Alternatively, and as depicted, locking body 16 includes a through-bore 22. Here, latching body 16 is configured to pass through through-bore 22.

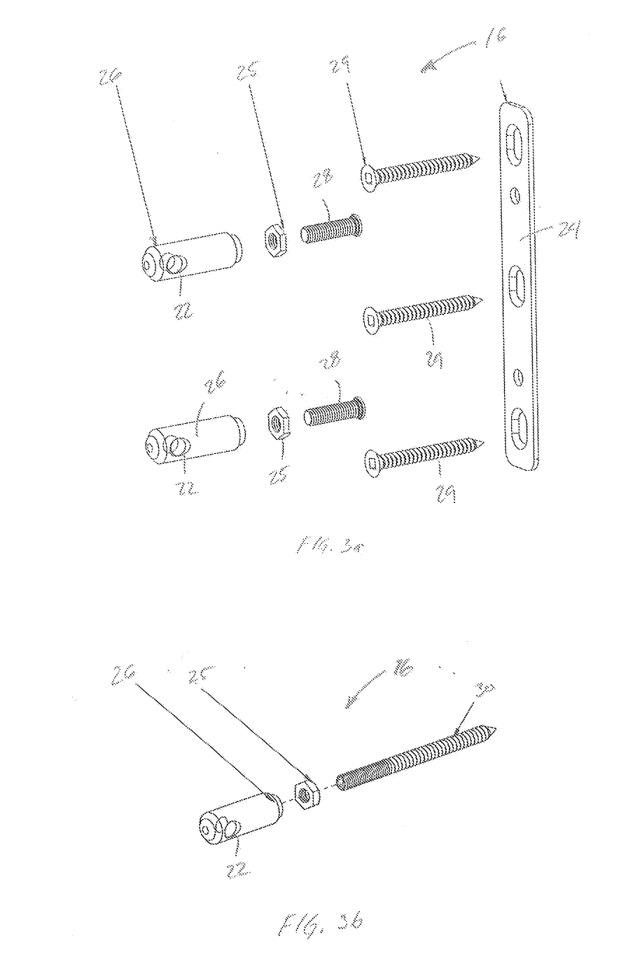

As best depicted in FIG. 3a, locking body 16 may be a locking plate 24 and a locking pin 26 perpendicularly disposed thereon. Locking plate 24 preferably includes threaded post 28 for locking pin 26 to threadedly attach and adjust thereto. A locknut 25 may be disposed between plate 24 and pin 26. In this embodiment, locking plate 24 is a flat plate for flush attachment (via screw 29) to the door jamb or to the second sliding door frame. Alternatively, and as depicted in FIG. 3b, locking body 16 could be a frame pin 30 and a locking pin 26 longitudinally disposed thereon. A locknut 25 may be disposed between frame pin 30 and pin 26. In this embodiment, frame pin 30 would threadedly affix into the door jamb or into the second sliding door. Still in the alternative, and as depicted in FIGS. 3c and 3d, locking body 16 may be a cross bar 34, holding plate 35 and a locking pin 26 perpendicularly disposed thereon. A locknut 25 may be disposed between cross bar 34 and pin 26. As such, cross bar 34 is connected across and through the door jamb 11 or second sliding door frame.

Referring back to FIGS. 1a, 1b, and 2, latching occurs by driving latching body 18 (as depicted, two latch pins 18) laterally into door frame/stile 14 to engage with locking body 16 (as depicted, two locking pins 26). This lateral drive is achieved by starting with lever 19 attached to a gear 36. Adjacent to lever gear 36 are three concentric cylindrical pieces: latch pin 18, a rotating sleeve 38 and inside bracket 40. The inner piece is latch pin 18 which is, at the outerside (towards the exterior side of the door), slim pin which projects from the inside of the interior face of the door frame/stile 14, through a bushing (not depicted) into the stile 14 cavity. The bushing may be a separate bushing held in place by a base plate (not depicted) or just a supporting hole in the base plate itself. Latch pin 18 is significantly larger diameter at its inner end. The inner end also has a vertical hole through it to receive a smaller pin (not depicted). The larger end of latch pin 18 fits neatly inside rotating sleeve 38 which is basically a cylinder with a double helix groove cut right through its sides. These two concentric cylindrical parts then slide into the third cylindrical part, inside bracket 40, which has two similar grooves cut into its sides except they are straight and travel laterally (an inside to outside direction) along most of the length of this bracket on the top and bottom of the cylinder. A flanged bushing 15 may be disposed between rotating sleeve 38 and inside bracket 40. Attached to the base of rotating sleeve 38 is a sleeve gear 39 which engages with lever gear 36. Thus, the levering of lever 19 rotates gear 36 and thus, inner sleeve 38 via sleeve gear 39. With all three cylindrical parts slid concentrically into each other, another pin (not depicted) is fastened such that it runs vertically, first through one of the slots of inside bracket 40 then though one of the visible sections of one of the helical grooves, then then through latch pin 18 and then through the other side of inner sleeve's 38 helical groove and then lastly through a straight groove of inside bracket 40. This unit of three concentric parts is fastened laterally so that it engages with lever gear 36 and projects lateraly, from the inside side of door 12, into frame/stile 14. When lever 19 turns gear 36 it rotates rotating sleeve 38. Since latch pin 18 is pinned through the straight lateral slots in inside bracket 40, which are fixed in place as the inside bracket is fixed in place, the latch pin is prevented from rotating. However, rotating sleeve 38 is rotating so the vertical pin in latch pin 18 is forced to move towards or away from the door frame/stile 14 to accommodate slots in both inner bracket 40 and rotating sleeve 38, thus driving latch pin 18 into and out of the door stile 14 where it can engage or disengage locking pin 26. All of the foregoing parts are housed in standard handle housing 17. Latch pin 18 may engage a pin receiver 27.

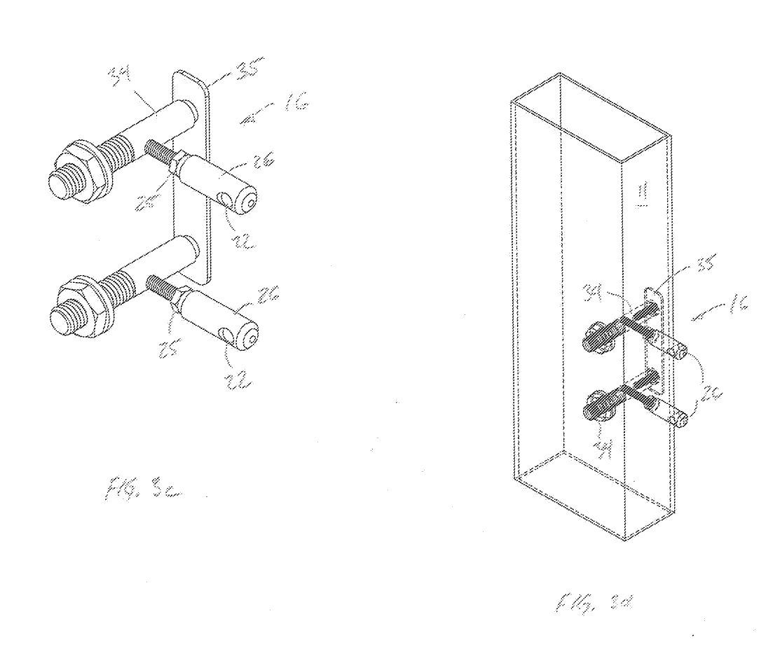

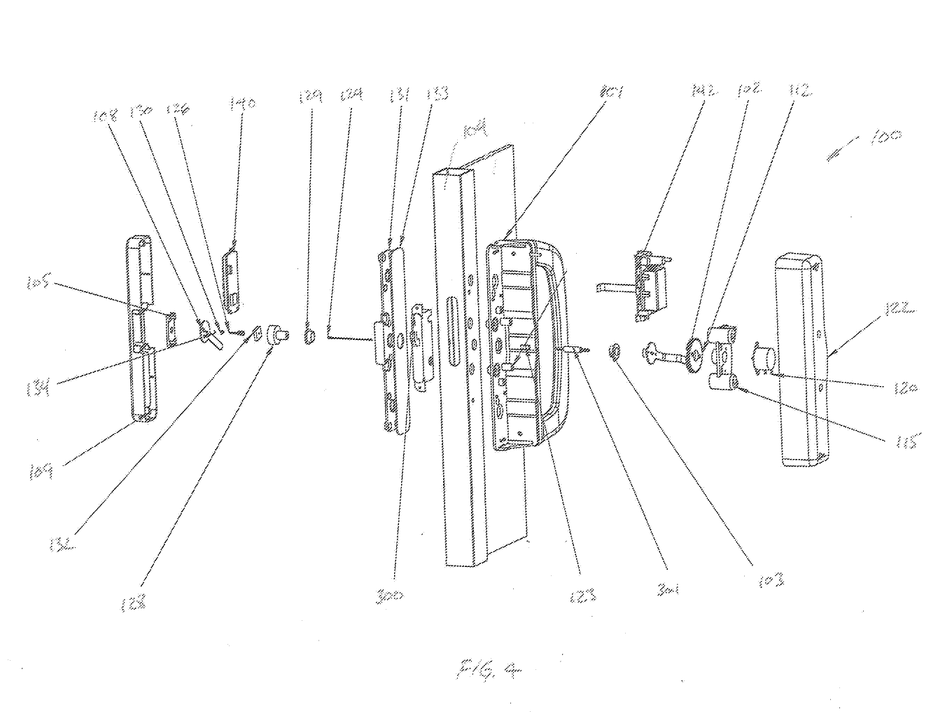

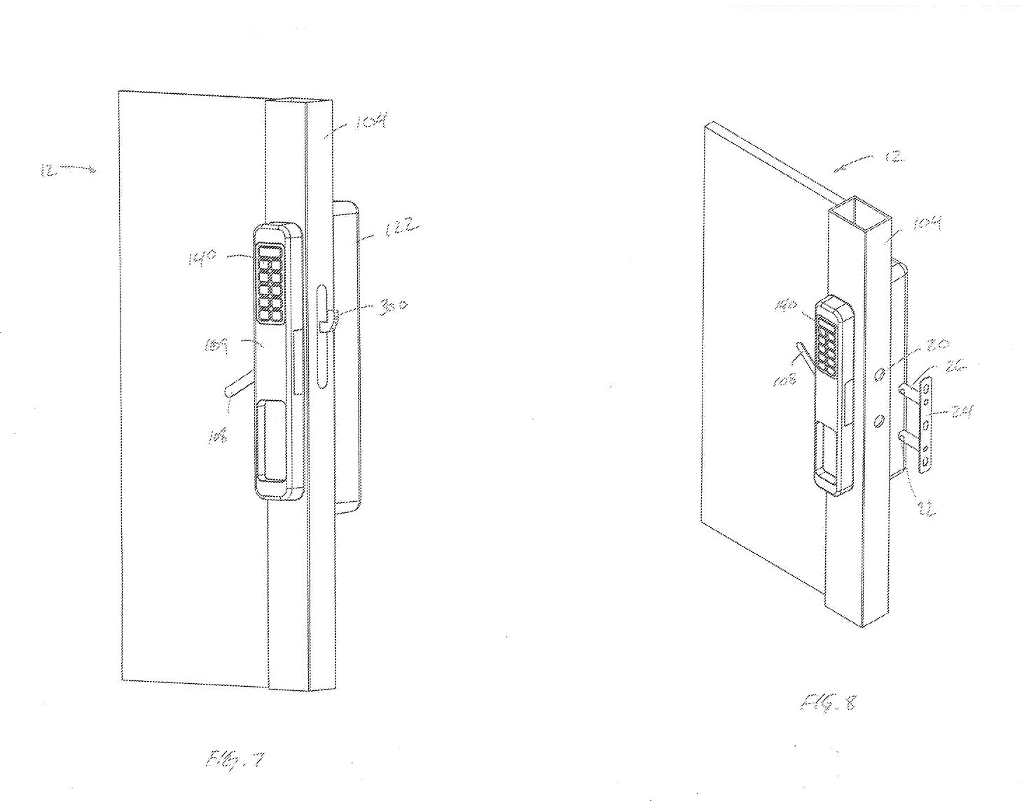

Traditional sliding doors have a frame that engages with a door jamb or a second sliding door frame. The first frame has an interior space exposure and an exterior space exposure. The first frame includes a latching body that engages with a corresponding locking body on the door jamb or second sliding door jamb. In the preferred, embodiment, the locking body and latching body would incorporate locking body 16 and latching body 18 from above. However, the present invention envisions the use of a typical hook and catch system of some existing sliding doors as well with an exterior controller or lever. Referring to FIGS. 4, 5, 6, 7 and 8 device 100 has a first controller 102 (akin to controller/lever 19 from above) connected to the interior space exposure of the first door frame 104 and operable to control a latching body 106 (as depicted, a latching pin 106). Here, first controller 102 is housed in standard handle housing 107 which generally consists of interior base and handle 101 and interior cover 122. A second controller 108 is connected to the exterior space exposure of the first door frame 104 and operable to control latching body 106. Here, second controller 108 is housed between an exterior handle 109 and an exterior base plate 131. A gasket 133 may be disposed between exterior base plate 131 and door frame 104. The controllers may be, for example, levers (as depicted), switches or knobs or the like. Device 100 also includes bypass means connected to the first sliding door frame 104 and in mechanical communication with second controller 108 and with latching body 106. Authentication means is included in communication with the bypass means, wherein the bypass means renders the second controller inoperable until the authentication means verifies a user.

Bypass means may be a jammer, such as a conventional key tumbler, which prevents second controller 108 from operating latching body 106 until the authentication means verifies a user.

Alternatively, the bypass means may be a clutch 107 that disengages the mechanical communication between second controller 108 and latching body 106 until the authentication means verifies a user. As depicted, controller lever 102 is always mechanically communicating with the latching body 106. When the latch is a third party mortise latch the communication is via a lever shaft 110 which passes from inside lever 102 outwards towards the exterior side of the door frame/stile 104. Along the way it engages and provides rotational force to operate the mortised latch.

When the latching mechanism includes a latching pin 106 (akin to latching pin 18 from above) then the rotational force from lever 102 is transmitted through gear 112 to sleeve gear 114 of a rotating sleeve 116 which, through that mechanism, activates and deactivates latch pin 106. Rotating sleeve 116 may sit in an inside bracket 115 and include a flanged bushing 119.

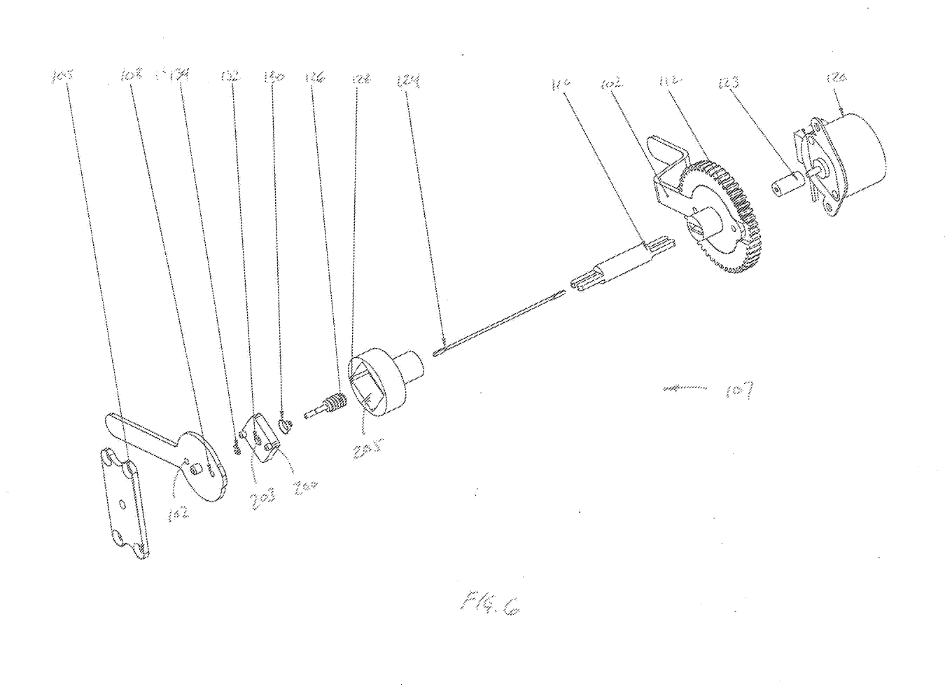

As best depicted in FIGS. 4 and 7, in the case of a 3^{rd}-party standard mortise latch 300, standard lever shaft 301 would have a square or slotted outer profile in the appropriate location and pass through a keyway in that latch which is typically square or slotted. Thus, rotation of lever shaft 301 would operate mortise latch 300.

Controller lever 108, which is located in the outside of frame 104, is engaged/disengaged via clutch 107. Lever 108 is also connected to a lever plate 105 which attaches to exterior handle 109. Upon authentication, a motor 120 (in a motorized embodiment and is powered by a battery—not depicted), located inside interior base 101, rotates a specific number of turns. It is coupled to (via motor shaft coupler 123) and in line with a clutch shaft 124. Clutch shaft 124 passes from the inside of panel 104 to the outside of the panel, traveling through the center of lever shaft 110 so that, in the case of a 3^{rd} party mortise latch 300 they both, concentrically pass through the same control keyway. Clutch shaft 124 is mostly a round rod that extends outwardly to approximately the outside face of door frame/stile 104 where a bladed end inserts into a slot on the inner end of a clutch drive shaft 126. When motor 120 turns clutch shaft 124, it turns clutch drive shaft 126. Clutch drive shaft 126 is a threaded rod a little bigger in diameter than clutch shaft 124 and is much like a bolt which threads inside the inward end of a clutch cup 128. Cutch cup 128 may be inserted into to a flanged bushing 129 which connects to exterior base 131. When rotated, clutch drive shaft 126 threadedly moves inwards and outwards with respective turns of motor 120. To engage clutch 107 clutch drive shaft 126 pushes a spring 130 which in turn pushes a clutch disc 132 outwardly, creating pressure from the clutch disc onto the inner face of exterior lever 108. Clutch disc 132 engages with lever 108 when pins 200, or other projection, in one engage with holes 202 in the other.

Since levers have only a limited rotational range, it is important to ensure that exterior lever 108 is in the correct orientation when it is engaged. This is done by spring loading the force of clutch drive shaft 126 onto clutch disc 132 even if the pins 200 and holes 202 are not yet engaged so that even once motor 120 has stopped its rotation and thus the Cclutch drive shaft has rotated and moved outwardly towards the clutch disc, spring 130 maintains plate/lever pressure. If they were not properly aligned during clutch drive shaft's 126 travel, the compression of spring 130 remains, keeping clutch disc 132 pressed against the misaligned lever 108. When operation is attempted, exterior lever 108 is rotated, bringing them into alignment and engagement occurs.

Disengagement of clutch 107 occurs by turns of motor 120 which turns clutch shaft 124 which turns clutch drive shaft 126 which retracts it towards the inside and away from exterior lever 108. Clutch driveshaft 126 has a narrow spindle which projects outwardly through spring 130 and through clutch disc 132 where it has a groove on its spindle which receives an e-clip 134 which does not fit through a hole 203 in the Cclutch disc, so it enables clutch drive shaft 126 to pull the Cclutch disc back with it, away from lever 108 to disengage the clutch 107 and the exterior lever 108.

Clutch disc 132 is shaped, such as a square, and fits neatly inside clutch cup 128 of a similar slightly larger square shaped cuphole 205. That lets clutch disc 132 to move inwardly and outwardly, but not to turn due to their matching close fit shapes. If clutch 107 is engaged, then when lever 108 turns, clutch disc 132 turns, turning clutch cup 128. The inner end of clutch cup 128 engages with lever shaft 110 to provide rotation to operate the latch whether it be the 3^{rd} party mortise latch 300 or a Pin-in-Pin latch 106.

In the case of a third party mortise latch 300 rotating standard lever shaft 301 transfers force via its close fit shape which travels through a control keyway in the mortise. In the case of the Pin in Pin latch, force is transferred from the rotating lever shaft 110 to the inner lever gear 112 and to the Pin in Pin latch 106.

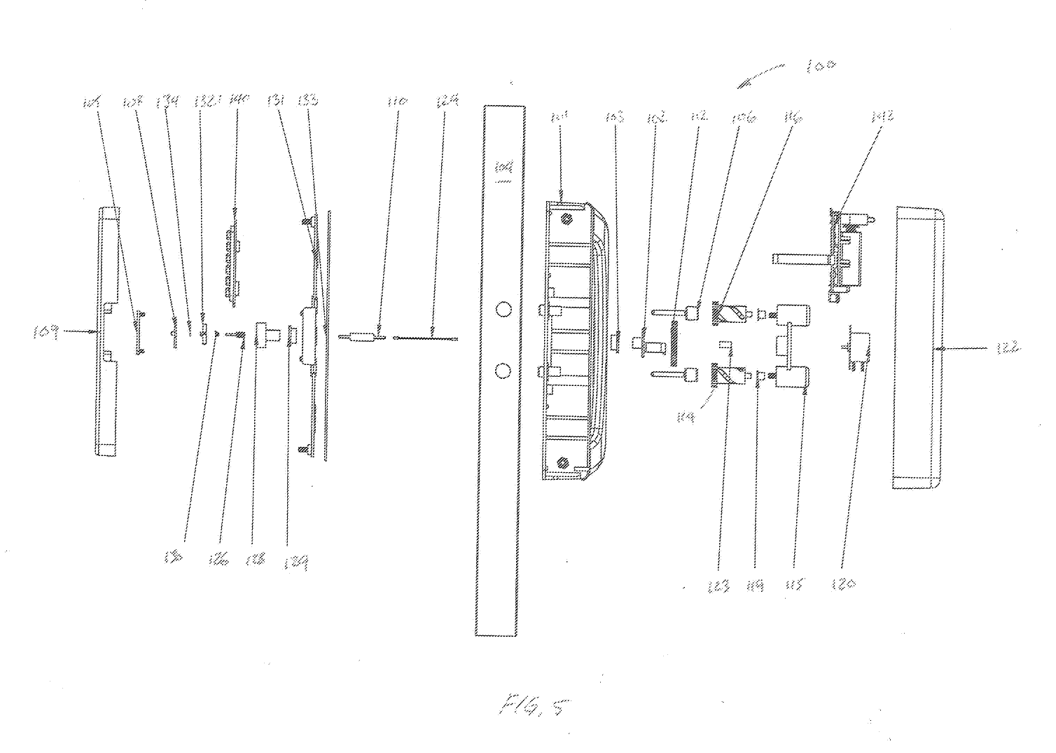

The authentication means is a key. As those skilled in the art will appreciate, the key can be a physical key, a key pad 140 (as best depicted in FIG. 6), a key fob, a key card, a bluetooth device, or any other device that grants access to a secure system. When the key is activated, the jammer or clutch 107 renders the second controller 108 operable to communicate with latching body 106. Keypad 140 may be in electronic communication with an interior cpu 142. Interior cpu 142, once the key has been activated, will activate clutch 107 to engage the mechanical communication between the second controller 108 and latching body 106. This engagement may, in certain instances, only occur when when the authentication means verifies a user and when second controller 108 is in alignment with the first controller 102.

While embodiments of the invention have been described and illustrated, such embodiments should be considered illustrative of the invention only. The invention may include variants not described or illustrated herein in detail. Thus, the embodiments described and illustrated herein should not be considered to limit the invention as construed in accordance with the accompanying claims.

What is claimed is:

1. A sliding door locking device, the sliding door having a frame that engages with a door jamb or a second sliding door frame, the device comprising:
a locking body connected to the door jamb or second sliding door frame, said locking body in linear alignment with a path of the first sliding door, the first sliding door frame being configured to receive said locking body;
a latching body connected to the first sliding door frame and operable to engage with said locking body; and
a controller connected to the first sliding door frame and operable to control said latching body towards and away from said locking body to lock and unlock with said locking body.

2. The locking device of claim 1 wherein said locking body and said latching body are in perpendicular alignment with one-another in the locked position.

3. The locking device of claim 1 wherein said locking body is configured for insertion into the first sliding door frame and the first sliding door frame is configured to receive said locking body within the first sliding door frame, wherein said locking body and said latching body lock to one-another inside of said first door frame.

4. The locking device of claim 1 wherein said latching body comprises a clip configured to engage over said locking body.

5. The locking device of claim 1 wherein said locking body comprises a through-bore and said latching body is configured to pass through said through-bore.

6. The locking device of claim 1 wherein said controller comprises a lever.

7. The locking device of claim 1 wherein said controller is inoperable until the first sliding door frame is engaged with the door jamb or with the second sliding door frame.

8. The locking device of claim 1 wherein said locking body comprises a locking plate and a locking pin perpendicularly disposed thereon, said locking plate configured for flush attachment to the door jamb or to the second sliding door frame.

9. The locking device of claim 1 wherein said locking body comprises a frame pin and a locking pin longitudinally disposed thereon, said frame pin configured for attachment into the door jamb or into the second sliding door.

10. The locking device of claim 1 wherein said locking body comprises a cross bar and a locking pin perpendicularly disposed thereon, said cross bar configured to connect across and through the door jamb or second sliding door frame.

11. A sliding door locking device, the sliding door having a frame that engages with a door jamb or a second sliding door frame, the first frame having an interior space exposure and an exterior space exposure, the first frame including a latching body that engages with a corresponding locking body on the door jamb or second sliding door jamb, the device comprising:
a first controller connected to the interior space exposure of the first door frame and operable to control the latching body;
a second controller connected to the exterior space exposure of the first door frame and operable to control the latching body;
bypass means connected to the first sliding door frame and in mechanical communication with said second controller and with the latching body; and
authentication means in communication with said bypass means, wherein said bypass means renders said second controller inoperable until said authentication means verifies a user.

12. The locking device of claim 11 wherein said bypass means comprises a jammer which prevents said second controller from operating the latching body until said authentication means verifies a user.

13. The locking device of claim 11 wherein said bypass means comprises a clutch that disengages said mechanical communication between said second controller and the latching body until said authentication means verifies a user.

14. The locking device of claim 12 wherein said authentication means comprises a key and wherein when said key is activated said jammer or clutch renders said second controller operable to communicate with the latching body.

15. The locking device of claim 13 wherein said authentication means comprises a key and wherein when said key is activated said jammer or clutch renders said second controller operable to communicate with the latching body.

16. The locking device of claim 14 wherein said jammer comprises a tumbler, wherein when said key engages said tumbler, said tumbler renders said second controller operable to communicate with the latching body.

17. The locking device of claim 13 wherein said clutch engages said mechanical communication between said second controller and the latching body when said authentication means verifies a user and when said second controller is in alignment with said first controller.

18. The locking device of claim 11 wherein said first and second controllers each comprise a lever.

19. The locking device of claim 11 wherein said bypass device is in mechanical communication with said second controller via a bypass body and said bypass body passes through a control arm for a mortise latch, wherein said control arm passes through a keyway hole in said mortise latch.

20. A sliding door locking device, the sliding door having a frame that engages with a door jamb or a second sliding door frame, the first frame having an interior space exposure and an exterior space exposure, the device comprising:
a locking body connected to the door jamb or second sliding door frame, said locking body in linear alignment with a path of the first sliding door, the first sliding door frame being configured to receive said locking body;
a latching body connected to the first sliding door frame and operable to engage with said locking body; and
a first controller connected to the interior space exposure of the first door frame and operable to control said latching body towards and away from said locking body to lock and unlock with said locking body;
a second controller connected to the exterior space exposure of the first door frame and operable to control said latching body;
bypass means connected to the first sliding door frame and in mechanical communication with said second controller and with said latching body; and
authentication means in communication with said bypass means, wherein said bypass means renders said second controller inoperable until said authentication means verifies a user.
